(19) United States
(12) Patent Application Publication
(10) Pub. No.: US 2024/0359137 A1
(43) Pub. Date: Oct. 31, 2024

(54) PROCESS OF BRINE CONCENTRATION AND METHOD FOR TREATMENT OF THE SAME

(71) Applicant: Qatar Foundation for Education, Science and Community Development, Doha (QA)

(72) Inventor: Abdelnasser Mabrouk, Doha (QA)

(21) Appl. No.: 18/645,165

(22) Filed: Apr. 24, 2024

Related U.S. Application Data
(60) Provisional application No. 63/462,849, filed on Apr. 28, 2023.

(51) Int. Cl. B01D 61/58; B01D 1/28; B01D 3/14; B01D 9/00; B01D 61/00; B01D 61/02; B01D 61/06; C02F 1/04; C02F 1/44; C02F 1/52; C02F 9/00; C02F 101/10

(52) U.S. Cl. CPC B01D 61/58; B01D 1/28; B01D 3/146; B01D 9/00; B01D 61/06; C02F 1/048; C02F 9/00; B01D 61/002; B01D 61/025; B01D 61/0271; B01D 2317/022; B01D 2317/025; B01D 2317/06; B01D 2317/08; C02F 1/041; C02F 1/441; C02F 1/442; C02F 1/445; C02F 1/52; C02F 2001/5218; C02F 2101/101; C02F 2301/08; C02F 2303/10; C02F 2303/22

(57) ABSTRACT

The present disclosure includes a process and method for brine concentration. A Nano filtration (NF) membrane removes divalent ions while permeating monovalent ions. In a sequential concentration process (membrane and thermal), the monovalent ions reach crystallization. The brine concentrator system can treat the brine of the desalination plants or the effluent of the industrial and chemical plants. The disclosed system can treat the produced water of the oil and gas sector. Two options are disclosed herein. In the first option, an RO system is used to recover water from an FO concentrator where in the second option the advanced MED-AB technology is used to recover water from the FO brine concentrator. The merit of the second option is explored where waste heat energy is available.

### PRIORITY CLAIM AND CROSS-REFERENCE TO RELATED APPLICATIONS

The present application claims the benefit of U.S. Provisional Application No. 63/462,849 filed Apr. 28, 2023, which is incorporated herein by reference in its entirety.

### FIELD

The present disclosure relates generally to a process and method to reduce energy consumption in brine concentration via a hybrid membrane and thermal brine concentration technique.

### BACKGROUND

Seawater desalination plants have increased worldwide to supply clean, fresh water. The proper treatment and management of brine generated in these plants presents significant environmental challenges as brine contains high concentrations of salt, organic matter, and contaminants. Brine discharged into the sea may harm aquatic life due to the induced salinity difference and the significant ion imbalance between brine and seawater.

The treatment options have been classified into four groups according to their final purpose: 1) technologies for reducing and eliminating brine disposal, 2) technologies for commercial salt recovery, 3) brine adaptation for industrial uses, and 4) metal recovery. Relatedly, the mining industry faces difficulties caused by reduced high-grade ores, an increase in energy demand, and environmental problems. Therefore, many countries are interested in recovering resources from seawater. Valuable elements extracted from seawater and seawater desalination brine include Na, Mg, Li, U, Ca, K, Sr, Br, B, Rb, and Cs.

The work carried by Mabrouk et. al., 2021 presents an improved evaporator design of the Multi Effect Distillation (MED) to minimize thermal losses and footprint of the evaporator. An advanced modular MED pilot plant has been installed with a nominal capacity of 25 m3/day to validate the concept under a seawater salinity of 57,500 ppm (Dukhan Coast, West of Qatar), at the top brine temperature of 65° C. Both the pilot testing and the simulation results confirm the features of the novel design of the MED. By implementing this invention's design, the heat transfer area has been decreased and accordingly, the capital cost of the evaporator is reduced by 20%. The tube arrangement with new vapor route allows the removal of the traditional demister, which accordingly reduces the footprint of the desalination plant by 65%. The sieve tray for spraying the seawater over the rectangular and inline tube bundle creates a uniform wettability. The improved design also discloses the utilization of an online vent water-ejector, for vent out of the non-condensable gases (NCGs). The novel evaporator design based low temperature MED technology, shows a potential solution for the industrial applications of high salinity by-product and solar desalination. Shahzada Aly, Husnain Manzoor, Simjo Simson, Ahmed Abotaleb, Jenny Lawler, Abdel Nasser Mabrouk. Pilot testing of a novel Multi Effect Distillation (MED) technology for seawater desalination. Desalination, 512 (2021) 115221. https://doi.org/10.1016/j.desal.2021.115221.

The work carried by Aly et. al. presents a novel integration of Multi Effect Distillation with Absorption compressor (MED-AB) to reduce the energy consumption and unit water cost. The MED-AB pilot plant has been installed with a nominal capacity of 25 m³/day to validate the concept under a seawater salinity of 57,500 ppm (West of Qatar). Both pilot testing and the simulation results confirm the features of the novel design of the MED-AB process. Simulation of a commercial evaporator of 15 MIGD capacity showed that the specific energy consumption of the proposed MED-AB is calculated as 4.8 kWh/m3, which is 60% lower than the existing MED-TVC plant (13 kWh/m3). Compared to the traditional MED-TVC, the seawater feed and pumping power of MED-AB process is lower by 70% and 55%. Shahzada Aly, Jasir Jawad, Husnain Manzoor, Simjo Simson, Jenny Lawler, Abdel Nasser Mabrouk. Pilot testing of a novel integrated Multi Effect Distillation-Absorber compressor (MED-AB) technology for high performance seawater desalination. Desalination, 512 (2022) 115388. https://doi.org/10.1016/j.desal.2021.115388.

Currently, the most concentrated metals such as sodium (Na), Mg, calcium (Ca), and potassium (K) are commercially extracted from the seawater, while lesser attention has been paid to the recovery of elements that are present in low concentration due to economical and operational challenges A study estimated that the successful recovery of Na, Mg, Ca, and K from desalination brine can lead to the generation of significant revenue (approximately US$ 18 billion/year). Important factors that need to be considered for the extraction of minerals from water are their concentration in brine and their market value. In this regard, recovery, or extraction of minerals with comparatively higher concentrations (>1 mg/L) in seawater (and hence brine) will be more feasible economically. The valuable minerals extracted from seawater brine can be employed in various industries. Minerals that can be profitably extracted from desalination brine have great potential for applications in medicine, environmental remediation, agriculture, and various chemical industries. Ihsanullah Ihsanullah, Jawad Mustafa, Abdul Mannan Zafar, M. Obaid, Muataz A. Atich, Noreddine Ghaffour. Waste to wealth: A critical analysis of resource recovery from desalination brine. Desalination 543 (2022)116093.

Based on the concentration and market price, the elements are divided into two broad classes, i.e., economically feasible and economically challenging. The potentially attractive elements for extraction include Na, Ca, Mg, K, Li, Sr, Br, B, I, and U. However, the major challenge is the development of more efficient, facile, and economical techniques of extraction.

Mickley et al. suggested many alternatives for different feed water compositions. Those alternatives are based on combinations of RO, lime softening (LS), thermal brine concentrator (BC), thermal crystallizer (CRYST), spray dryer (SD), evaporation ponds (EP) and landfill (LF) to treat brackish water with recoveries over 96%. They concluded that evaporation ponds and landfills are the biggest costs. M. Mickley, Survey of High-recovery and Zero Liquid Discharge Technologies for Water Utilities, Wate Reuse Foundation, 2008.

Mukhopadhyay patented a high-efficiency RO process (HERO™) to enhance RO water production. This technology was developed to produce ultra-pure water for the electronics industry, but many authors have recently studied its applicability to two-stage RO. This process consists of three steps. The first step is to adjust the hardness-to-alkalinity ratio of the feed water, which is typically done by alkali addition. The second step involves the use of a weak acid cation (WAC) exchange resin. The WAC resin removes hardness quantitatively, given the proper hardness to alkalinity ratio of the influent. The third stage is degasification for carbon dioxide elimination followed by increasing pH up to 10.5 or higher adding NaOH (2). These steps allow higher recovery in the second RO. In this manner, species such as SiO₂ become highly ionized and their rejection by the membrane separation process is significantly increased, and (b) their solubility in the reject stream from the membrane process is significantly increased. Passage of weakly ionized species such as boron, SiO₂ or TOC is reduced by a factor of ten or more. A recovery ratio of 90% or higher is achievable with most brackish feed waters, while simultaneously achieving a substantial reduction in cleaning frequency. Mukhopadhyay D., Method and apparatus for high efficiency reverse osmosis operation, U.S. Pat. No. 5,925,255, (1999).

Rahardianto et al. used the HERO™ process for achieving high product water recovery (95%) for desalting brackish water from the Colorado River. The feed water had 950 mg TDS/L, mainly sodium but also SiO₂, boron, calcium, barium, magnesium, and bicarbonate in small amounts. The results demonstrated that the HERO™ process can achieve 95% to 98% recovery ratios with estimated energy requirements from 11 to 19 kWh/m3. Rahardianto A., J. Gao, C. J. Gabelich, M. D. Williams, Y. Cohen, High recovery membrane desalting of low-salinity brackish water: integration of accelerated precipitation softening with membrane RO, J. Membr. Sci. 289 (2007) 123-137.

An integrated membrane system has been developed by et al. to recover dissolved salts that are present, at low concentration, in typical feed streams to desalination plants. The experimental work aimed to obtain CaCO₃, NaCl and MgSO₄·7H₂O as solid products from nanofiltration retentate. Since gypsum scale causes reduction of SO₄²⁻ content in the solution and drastically limits the recovery of epsomite, Ca²⁺ ions have been almost quantitatively precipitated by reaction with NaHCO₃/Na₂CO₃. Sodium (bi) carbonate solutions have been produced by reactive absorption of CO₂ into sodium hydroxide solutions carried out by membrane contactors technology. The flow sheet has been completed with a membrane crystallization stage that allows the generation of supersaturation for salts crystallization. Enrico Drioli, Efrem Curcio, Alessandra Criscuoli, Gianluca Di Profio, Integrated system for recovery of CaCO3, NaCl and MgSO4·7H2O from nanofiltration retentate. Journal of Membrane Science 239 (2004) 27-38.

In the work carried out by Al-Rawaifch et al. the effect of salts precipitators (SP) and nano-filtration (NF) on the scale deposits of multistage flash (MSF) is studied using the Skillman index for estimating the likelihood of calcium sulphate scaling. The analysis was carried out to study the sulphate scale potential for seawater with 0 to 100% pre-treated make-up in an MSF reference plant. The results showed that the scale potential increases with increasing temperature and decreases with increasing the percentage of either SP or NF-treated feed. For seawater with no feed pre-treatment, the scale can start depositing at 115° C. However, the maximum top brine temperature (TBT), at which sulfate scale begins to precipitate, is shifted to higher temperatures with increased pre-treated portion. For 100% SP-treated feed, TBT reached 170° C. The temperature is shifted to 120, 135, and 145° C. when the NF-treated portion increases to 10, 25, and 50%, respectively. For 100% NF feed pre-treatment, TBT can reach as high as 175° C. Aiman E. Al-Rawajfeh, Hassan E. S. Fath, A. Nasser Mabrouk, “Integrated Salts Precipitation and Nano-Filtration as Pretreatment of Multistage Flash Desalination System”. Heat Transfer Engineering, 33 (3), 33, 272-279, (2011), http://dx.doi.org/10.1080/01457632.2011.562776.

In the work of Mabrouk et al., the techno-economic analysis of a newly developed high performance multistage flash configuration with de-aeration and brine mix (MSF-DM) is presented. The techno-economic analysis also includes the use of Nano filtration (NF) as a pre-treatment method for MSF to increase its top brine temperature (TBT) to 130° C. A mathematical model of NF membrane is developed and verified using Visual Design and Simulation program for typical operating NF unit (Umlluj, KSA). The techno-economic analysis of integrating NF pre-treatment for both the existing multistage flash-brine recirculation (MSF-BR) and newly developed MSF-DM configurations is performed. Integration of NF system to existing MSF desalination plant and treatment of only 30% of make-up enable to increase the TBT up to 130° C., the production can be increased to 19%. The cost analysis showed the unit product cost is 5.4% higher than that of conventional MSF-BR (TBT=110° C.) due to the additional capital cost of NF system. Integrating NF system to new configuration (NF-MSF-DM) desalination plant at the TBT=130° C., the gain output ratio could be as high as 16,i.e. double the convention MSF-BR. The new NF-MSF-DM configuration significantly reduces the unit's input thermal energy to suit the use of (the relatively expensive) solar energy as a desalination plant driver. On the other hand, the levelized water cost of NF-MSF-DM (at TBT=130° C.) is 14% lower than conventional MSF at (TBT=110° C.) at the current oil price of 104 $/bbl. Abdel Nasser Mabrouk and Hassan Elbanna Fath. “Techno-economic analysis of hybrid high performance MSF desalination plant with NF membrane”. Desalination and Water Treatment, (2012) http://dx.doi.org/10.1080/19443994.2012.714893

The work of Mabrouk et.al. presented experimental results of a renewable energy driven, high performance Multi Stage Flash (MSF) desalination unit integrated with Nano Filtration (NF) membrane. The desalination pilot test is built to evaluate the performance of the novel De-aeration and brine Mix (MSF-DBM) configuration. The NF pilot is built to enable MSF desalination unit the operation at high brine temperature (TBT). The capacity of the desalination pilot plant is 1.0 m³/day of water. The whole pilot plant is installed at Wadi El-Natron (Egypt). This paper presents the first phase of the project including the pilot test description, and experiments of concentrated solar trough, steam generator, NF, and MSF units. Comparison between the simulation and the experimental results of the pilot unit' subsystems are relatively satisfactory. The newly developed NF-MSF-DBM configuration is tested at TBT=100° C. and the GOR is calculated as 15 which almost twice of traditional MSF under the same operating conditions. The newly high-performance NF-MSF-DBM desalination unit significantly reduces the unit's input thermal energy which make the integration with (the relatively expensive) renewable energy as a desalination plant driver is a viable option. Abdel Nasser Mabrouk and Hassan El-banna S. Fath. “Experimental Study of High Performance hybrid NF-MSF Desalination Pilot Test Unit driven by Renewable Energy”. Desalination and Water Treatment, (2013), http://dx.DOI: 10.1080/19443994.2013.773860.

The work of Altaee et al. introduced a novel conceptual design of integrating Forward Osmosis (FO) membrane with the Multi Stage Flashing (MSF) or Multi Effect Distillation (MED) thermal desalination processes. A simple mathematical model was developed here to estimate the performance of the FO membrane system. A previously developed program, VDS, for estimating the performance of thermal processes was updated to include the FO system. The verified VDS program was applied to simulate the performance of the FO-MSF/MED hybrid system at different recovery rates varied from 16% to 32%. Brine reject from the thermal desalination processes was recycled and used as a draw solution to reduce the cost of FO membrane pretreatment. Seawater was used as the donor solution in the FO membrane. The simulation results showed that the FO pretreatment, successfully, reduced the concentration of multivalent ions in the feed solution to the MSF and MED. It was found that the concentrations of Ca₂+, Mg²⁺, and SO₄^{2 -} ions, which are responsible for scale problem in MSF, decreased with increasing the recovery rate of FO membrane. In case of FO-MED hybrid system, the thickness of the CaCO₃ scale layer was calculated at different FO recovery rates. The estimated thickness of CaCO₃ scale layer was 74 μm, 43 μm, and 39 μm for 0%, 20%, and 32% FO recovery rate respectively. It was also found that the thickness of CaCO₃ scale layer decreased in the direction from effect 1 to effect 6 due to temperature drop. Finally, the study demonstrated the feasible application of FO membrane in the pretreatment of seawater to reduce the concentration of multivalent ions which are responsible for the scale problem in the thermal desalination processes. Ali Altaee, Abdel Nasser Mabrouk, Karim Borouni. A novel Forward Osmosis Membrane Pretreatment of Seawater for Thermal Desalination Processes. Desalination, 326, pp. 19-26, (2013). https://doi.org/10.1016/j.desal.2013.07.008.

In the work of Altaee et al., forward osmosis (FO) seawater pretreatment was proposed for the removal of scale ions from seawater to the thermal desalination plant. In the current study, previously developed models were applied to estimate the effectiveness of FO pretreatment in the removal of divalent ions from feed solution to MSF/MED at elevated temperatures. The simulation results showed that the water and salt flux across the FO membrane increased with increasing the seawater salinity. However, for given seawater salinity, the water and salt flux across the FO membrane decreased with increasing the FO recovery rate. It was found that the concentration of Ca₂⁺, Mg₂⁺ and SO₄^{2 -} ions increased with increasing the operating temperature in the thermal plant but decreased with increasing the recovery rate of the FO pretreatment. Additionally, an FO pretreatment-MED Scale Index (FMSI) was developed to determine the required FO recovery rate and avoids scale problems at different MED operating temperatures. Initially, Ryznar Scale Index (RSI) of the feed solution was calculated for different MED operating temperatures. Then, RSI was plotted against the FO recovery rates and the desirable FO recovery rate was determined from the plot based on the operating temperature of the MED plant. The scale index was also applied to determine the required mixing ratio of NF permeate-makeup water in the NF-MED desalination hybrid system. The application of the FO pretreatment-MED Scale Index has the potential to reduce the required time and resources to determine the desirable FO/NF pretreatment ratio of feed water to the MED plant. Ali Altaee, Abdel Nasser Mabrouk, Karim Borouni. Forward osmosis pretreatment of seawater to thermal desalination: High temperature FO-MSF/MED Hybrid System. Desalination 339 (2014) 18-25. https://doi.org/10.1016/j.desal.2014.02.006.

For Zero Liquid Discharge (ZLD) technology, the current approach of the conventional technology (thermal brine concentration with crystallizer) is not feasible due to its intensive energy consumption. It generates mixing salts which need complex processing to separate valuable salt from NaCl. Since the new trend is looking to the valorization of brine, there is a need for a configuration to separate some valuable salt in the upstream instead piled with NaCl after crystallizer.

### SUMMARY

Example systems, methods, and apparatus are disclosed herein for brine concentration and brine treatment.

In light of the disclosure herein, and without limiting the scope of the invention in any way, in a first aspect of the present disclosure, which may be combined with any other aspect listed herein unless specified otherwise, a method for brine concentration and water recovery including: feeding a brine stream into a first stage nano filtration process, feeding a rejected stream from the first stage nano filtration process to a second stage nano filtration process, feeding a permeate stream from the first stage nano filtration process to a first reverse osmosis system, feeding a brine concentrate stream of the second state nano filtration to the feed side of a third nano filtration process, and directing the brine concentrate stream to a brine mining process, recovering a first pressure energy from the brine concentrate stream via a first energy recovery system, mixing the brine rejects of the first reverse osmosis system and a permeate stream from the second stage nano filtration process into a first mixed stream, subjecting the first mixed stream to a pressure greater than osmotic pressure, directing the mixed stream to a feed side of a forward osmosis system including an osmotic membrane, where the osmotic membrane is fluidly coupled to a second reverse osmosis system on a dilute side opposite the feed side, such that there is a pressure differential between the first mixed stream on the feed side of the osmotic membrane and the second reverse osmosis system on the dilute side, where the dilute side has low pressure and the feed side has high pressure; diluting the first mixed stream and directing the diluted mixed stream to the second reverse osmosis system, recovering a second pressure energy from the diluted mixed stream via a second energy recovery system, where the pressure energy is reverted to the second osmosis system, mixing a concentrated mixed stream from the dilute side with a permeate stream from the third stage nano filtration into a second mixed stream, and directing the second mixed stream into a thermal brine concentrator. The nano filtration process separates divalent ions from the brine stream the first reverse osmosis system generates a potable freshwater stream. The first pressure energy is reverted to the brine stream to reduce energy consumption of the first, second, and third state nano filtration processes.

In a second aspect of the present disclosure, which may be combined with any other aspect listed herein unless specified otherwise, the brine stream has a salinity of 50-90 g/L.

In a third aspect of the present disclosure, which may be combined with any other aspect listed herein unless specified otherwise, the brine mining process comprises subjecting the brine concentrate stream to further precipitation of the CaCo₃ and MgSO₄ salts using a chemical approach.

In a fourth aspect of the present disclosure, which may be combined with any other aspect listed herein unless specified otherwise, the chemical approach separates the divalent ions before reaching supersaturation.

In a fifth aspect of the present disclosure, which may be combined with any other aspect listed herein unless specified otherwise, the thermal bring concentration comprises a vapor compressor and an evaporator.

In a sixth aspect of the present disclosure, which may be combined with any other aspect listed herein unless specified otherwise, the vapor compressor circulates vapor to increase pressure and to heat the evaporator.

In a seventh aspect of the present disclosure, which may be combined with any other aspect listed herein unless specified otherwise, an overall water recovery from the initial brine stream is 60-80%.

In an eight aspect of the present disclosure, which may be combined with any other aspect listed herein unless specified otherwise, a resulting feed brine leaves the evaporator with a salinity of about 250-300 g/L before being directed to a crystallizer.

In a second aspect of the present disclosure, which may be combined with any other aspect listed herein unless specified otherwise, a method for brine concentration and water recovery including: feeding a brine stream into a first stage nano filtration process, feeding a rejected stream from the first stage nano filtration process to a second stage nano filtration process, feeding a permeate stream from the first stage nano filtration process to a first reverse osmosis system, feeding a brine concentrate stream of the second state nano filtration to the feed side of a third nano filtration process, and directing the brine concentrate stream to a brine mining process, recovering a first pressure energy from the brine concentrate stream via a first energy recovery system, mixing the brine rejects of the first reverse osmosis system and a permeate stream from the second stage nano filtration process into a first mixed stream, subjecting the first mixed stream to a pressure greater than osmotic pressure, directing the mixed stream to a feed side of a forward osmosis system including an osmotic membrane, where the osmotic membrane is fluidly coupled to a Multi Effect Distillation with Absorption compressor (MED-AB) thermal brine concentrator system on a dilute side opposite the feed side, such that there is a pressure differential between the first mixed stream on the feed side of the osmotic membrane and the Multi Effect Distillation with Absorption compressor (MED-AB) thermal brine concentrator system on the dilute side, where the dilute side has low pressure and the feed side has high pressure; diluting the first mixed stream and directing the diluted mixed stream to the Multi Effect Distillation with Absorption compressor (MED-AB) thermal brine concentrator system, recovering a second pressure energy from the diluted mixed stream via a second energy recovery system, where the pressure energy is reverted to the second osmosis system, mixing a concentrated mixed stream from the dilute side with a permeate stream from the third stage nano filtration into a second mixed stream, and directing the second mixed stream into a thermal brine concentrator. The nano filtration process separates divalent ions from the brine stream the first reverse osmosis system generates a potable freshwater stream. The first pressure energy is reverted to the brine stream to reduce energy consumption of the first, second, and third state nano filtration processes.

In a tenth aspect of the present disclosure, which may be combined with any other aspect listed herein unless specified otherwise, the brine stream has a salinity of 50-90 g/L.

In an eleventh aspect of the present disclosure, which may be combined with any other aspect listed herein unless specified otherwise, the brine mining process comprises subjecting the brine concentrate stream to further precipitation of the CaCo₃ and Mg SO₄ salts using a chemical approach.

In a twelfth aspect of the present disclosure, which may be combined with any other aspect listed herein unless specified otherwise, the chemical approach separates the divalent ions before reaching supersaturation.

In a thirteenth aspect of the present disclosure, which may be combined with any other aspect listed herein unless specified otherwise, the thermal bring concentration comprises a vapor compressor and an evaporator.

In a fourteenth aspect of the present disclosure, which may be combined with any other aspect listed herein unless specified otherwise, the vapor compressor circulates vapor to increase pressure and to heat the evaporator.

In a fifteenth aspect of the present disclosure, which may be combined with any other aspect listed herein unless specified otherwise, an overall water recovery from the initial brine stream is 60-80%.

In a sixteenth aspect of the present disclosure, which may be combined with any other aspect listed herein unless specified otherwise, a resulting feed brine leaves the evaporator with a salinity of about 250-300 g/L before being directed to a crystallizer.

In a seventeenth aspect of the present disclosure, any of the structure, functionality, and alternatives disclosed in connection with any one or more of FIGS. 1 to 13 may be combined with any other structure, functionality, and alternatives disclosed in connection with any other one or more of FIGS. 1 to 13.

In light of the present disclosure and the above aspects, it is therefore an advantage of the present disclosure to provide users with a process and method to reduce energy consumption in brine concentration via a hybrid membrane and thermal brine concentration technique.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIGS. 1A-1B show a brine concentrator and water recovery process, according to an example embodiment of the present disclosure.

FIGS. 2-4 show results for a mathematical model of a Nano Filtration (NF) membrane, according to an example embodiment of the present disclosure.

FIG. 5 shows a Nano Filtration (NF) pilot plant desalination lab (QEERI), according to an example embodiment of the present disclosure.

FIG. 6 shows Nano Filtration (NF) membrane characterization determining A and B coeffect, according to an example embodiment of the present disclosure.

FIG. 7 shows a process simulation of the Osmotic Assisted Reverse Osmosis Membrane (FO) System, according to an example embodiment of the present disclosure.

FIG. 8 shows a hollow fibre Osmotic Assisted Reverse Osmosis Membrane (FO) membrane set up, according to an example embodiment of the present disclosure.

FIG. 9 shows results for a mathematical model of a Reverse Osmosis (RO) membrane, according to an example embodiment of the present disclosure.

FIG. 10 shows results for a mathematical model of a Forward Feed MED process, according to an example embodiment of the present disclosure.

FIG. 11 shows results for a mathematical model of a brine concentrator and water recovery process, according to an example embodiment of the present disclosure.

FIG. 12 shows results for a mathematical model of a Forward Feed Multi Effect Distillation with Absorption compressor (MED-AB) process, according to an example embodiment of the present disclosure.

FIG. 13 shows an advanced Multi Effect Distillation with Absorption compressor (MED-AB) pilot plant at Dukhan, Qatar, according to an example embodiment of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Methods, systems, and apparatus are disclosed herein for a process and method to reduce energy consumption in brine concentration via a hybrid membrane and thermal brine concentration technique.

While the example methods, apparatus, and systems are disclosed herein a brine concentration and brine treatment, it should be appreciated that the methods, apparatus, and systems may be operable for other water treatment applications.

The present disclosure generally relates to brine concentration and brine treatment. The present disclosure provides an innovative process and method to reduce energy consumption via a unique hybrid membrane and thermal brine concentration system technique. The NF system is used to separate divalent ions (Ca, Mg, SO4, . . . ) from the brine of the desalination plant with expected salt rejection higher than 90%. Separation of the divalent salts and permeate-only monovalent ions will enable both brine concentrator-based FO membrane and based thermal to operate at a higher concentration ratio without scale precipitations of CaCO3 and CaO4, accordingly increasing the overall process recovery ratio. Another feature is to produce of pure NaCl after the crystallization process.

The overall water recovery ratio is about 85% with reduced energy consumption. The disclosure either concentrating all brine to the crystallization or concentrate part of it and the rest will be treated and retaining it to its salinity value.

A nano filtration (NF) membrane is used to remove the divalent ions while permeating the monovalent ions. In a sequential concentration process (membrane and thermal), the monovalent ions reach the crystallization. The brine concentrator system can treat, for example, the brine of the desalination plants or the effluent of the industrial and chemical plants. The system can treat, for example, the produced water of the oil and Gas sector.

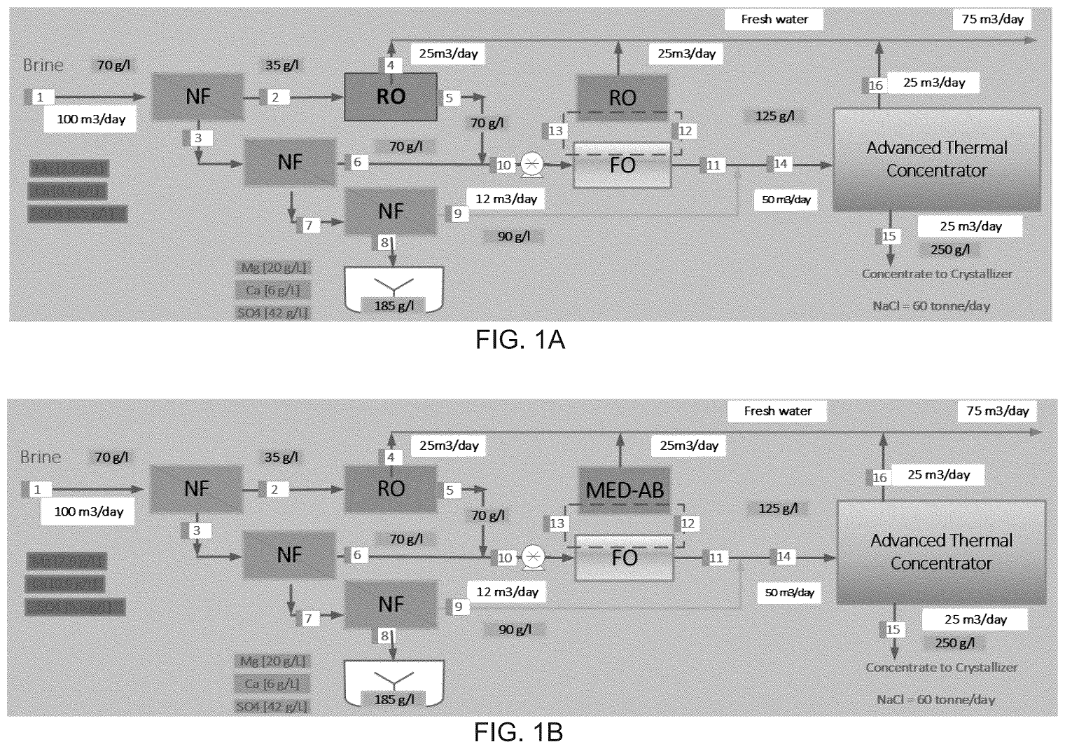

First Embodiment. FIG. 1A shows a brine concentrator and water recovery process. As seen in FIG. 1A, a brine stream (1) of salinity 50-90 g/L is fed to the first stage NF process, where the divalent ions are separated, and the rejected stream (3) is directed to the second stage NF for further concentration. The permeate stream of the first stage NF (2) is directed to a seawater (Reverse Osmosis) RO system to generate potable freshwater stream (4).

The brine concentrate of the second stage NF (7) is directed to the feed side of the third NF stage for further concentration stream (8) and directed to the brine mining process, which is subjected to a further precipitating of the CaCO₃ and Mg SO₄ salts using a chemical approach. This action separates the divalent ions before reaching supersaturating, which is borne for scale growth and potential precipitation inside the separation process. This action avoids fouling the brine concentration-based osmotic membrane (FO process).

The NF system is equipped with an energy recovery system to recover the pressure energy from the streams (8) and revert it to the stream (1) to reduce the energy consumption of the NF system. The permeate of the third stage NF system is directed to the thermal concentrator (9). The brine rejects of the RO (5) and the permeate stream of the second NF stage (6) are mixed in one stream (10) and then pressurized before FO membrane.

The brine of stream (10) is subjected to higher pressure (greater than osmotic pressure) before directing to the feed side of the osmotic membrane (FO). The stream (13) is controlled to be the same concentration of the stream (10) by using RO system. Due to the pressure difference across the osmotic membrane, the permeate water crosses the membrane from the feed side (high pressure) to the dilute side (low pressure). The diluted stream (12) is directed to the RO plant. The RO system is also equipped with an energy recovery system to recover the pressure energy from the stream (13) and revert it to the stream (12) to reduce the energy consumption of the RO system.

The concentrated stream (11) leaves the FO system at a higher concentration at about 125 g/L and higher pressure. The FO system is equipped with an energy recovery system to recover the pressure energy from the stream (11) and revert it to the stream (10) to reduce the energy consumption of the FO system. Both streams (11) and (9) are mixed into the stream (14) and directed to the thermal brine concentrator. The thermal brine concentrator consists of multiple effect evaporators conceded in series (Forward Feed).

The thermal brine concentrator is equipped with a vapor compressor (Energy recovery system). The vapor of the last effect is circulated using a vapor compressor to increase its pressure and used as a heating source to run the evaporator. The overall water recovery of the system is about 75%. The feed brine leaves the evaporator with a salinity of about 250-300 g/l before being directed to the crystallizer.

Additional Embodiment. FIG. 1B shows a brine concentrator and water recovery process. As seen in FIG. 1B, a brine stream (1) of salinity 50-90 g/L is fed to the first stage NF process, where the divalent ions are separated, and the rejected stream (3) is directed to the second stage NF for further concentration. The permeate stream of the first stage NF (2) is directed to a seawater Reverse Osmosis (RO) system to generate potable freshwater stream (4).

The brine concentrate of the second stage NF (7) is directed to the feed side of the third NF stage for further concentration stream (8) and directed to the brine mining process, which is subjected to a further precipitating of the CaCO₃ and Mg SO₄ salts using a chemical approach. This action separates the divalent ions before reaching supersaturating, which is borne for scale growth and potential precipitation inside the separation process. This action avoids fouling the brine concentration-based osmotic membrane (FO process).

The NF system is equipped with an energy recovery system to recover the pressure energy from the streams (8) and revert it to the stream (1) to reduce the energy consumption of the NF system. The permeate of the third stage NF system is directed to the thermal concentrator (9). The brine rejects of the RO (5) and the permeate stream of the second NF stage (6) are mixed in one stream (10) and then pressurized before FO membrane.

The brine of stream (10) is subjected to higher pressure (greater than osmotic pressure) before directing the feed side of the osmotic membrane (FO). The stream (13) is controlled to be the same concentration of the stream (10) by using an MED-AB (thermal brine concentrator) system. Due to the pressure difference across the osmotic membrane, the permeate water crosses the membrane from the feed side (high pressure) to the dilute side (low pressure). The diluted stream (12) is directed to the MED-AB (thermal brine concentrator) system. The MED-AB (thermal brine concentrator) system is also equipped with an energy recovery system to recover the pressure energy from the stream (13) and revert it to the stream (12) to reduce the energy consumption of the MED-AB (thermal brine concentrator) system.

The concentrated stream (11) leaves the FO system at a higher concentration at about 125 g/L and higher pressure. The FO system is equipped with an energy recovery system to recover the pressure energy from the stream (11) and revert it to the stream (10) to reduce the energy consumption of the FO system. Both streams (11) and (9) are mixed into the stream (14) and directed to the thermal brine concentrator. The thermal brine concentrator consists of multiple effect evaporators conceded in series (Forward Feed).

The thermal brine concentrator is equipped with a vapor compressor (Energy recovery system). The vapor of the last effect is circulated using a vapor compressor to increase its pressure and used as a heating source to run the evaporator. The overall water recovery of the system is about 75%. The feed brine leaves the evaporator with a salinity of about 250-300 g/l before being directed to the crystallizer.

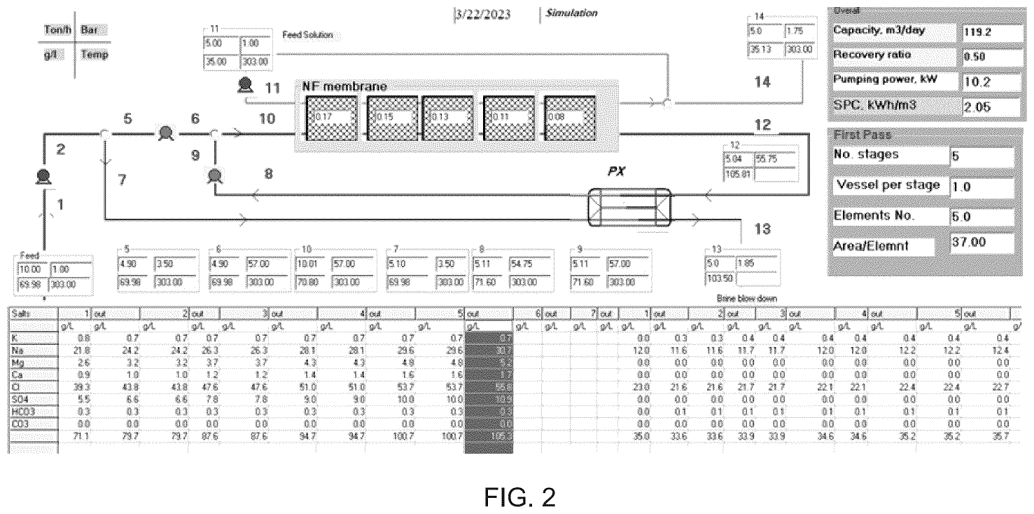

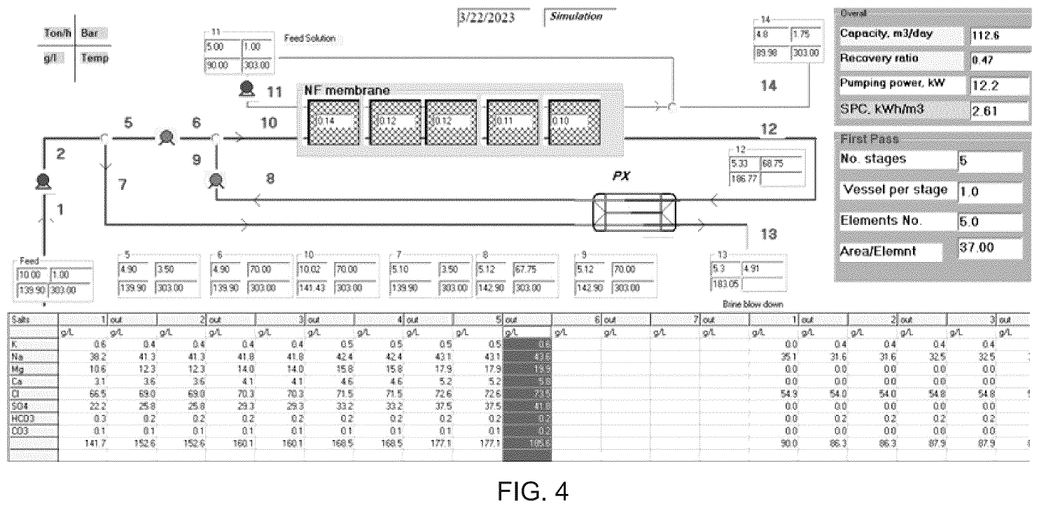

Simulation Results: The Disclosed Invention includes a mathematical model of the NF system. A computer program (VSP) solves the mathematical model equations. By solving the mathematical model, the process performance is calculated. The process production and recovery are calculated. The composition of seawater is fed (input) to the VSP software, and the number of membrane elements. The species of the inorganic salt concentration are calculated for each stream as seen in FIGS. 2-4.

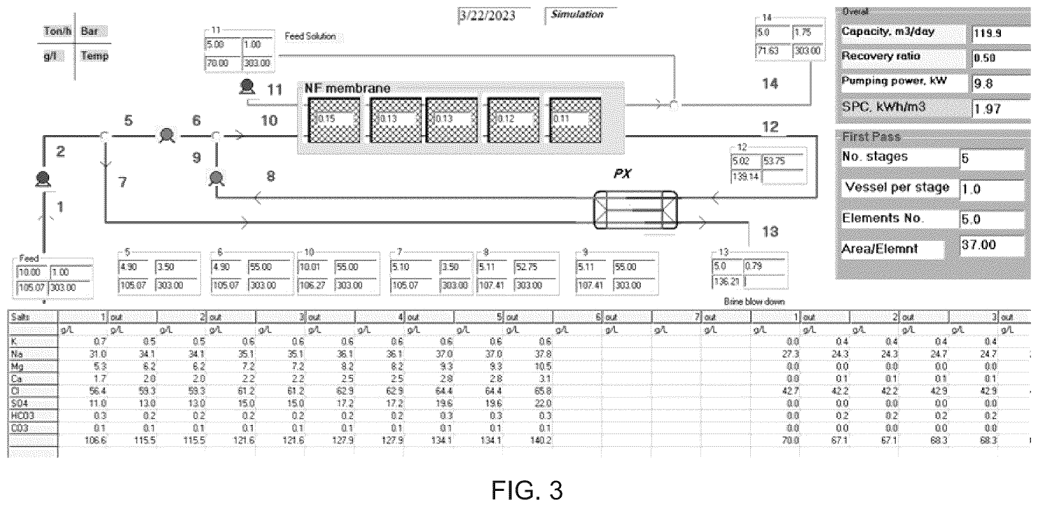

Specifically, FIGS. 2-4 show results for a mathematical model of a Nano Filtration (NF) membrane. For FIG. 2, showing salt rejection, A=1.8 LMH/bar, Rj_K=0.36, Rj_Na=0.51, Rj_Mg=0.999, Rj_Ca=0.999, Rj_SO₄=0.999, Rj_Cl=0.51, Rj_HCO₃=0.36, and Rj_Co₃=0.8. For FIG. 3, showing salt rejection, A=1.5 LMH/bar, Rj_K=0.26, Rj_Na=0.26, Rj_Mg=0.998, Rj_Ca=0.86, Rj_SO₄=0.999, Rj_Cl=0.26, Rj_HCO₃=0.26, and Rj_Co₃=0.8. For FIG. 3, showing salt rejection, A=1.0 LMH/bar, Rj_K=0.19, Rj_Na=0.19, Rj_Mg=0.998, Rj_Ca=0.96, Rj_SO₄=0.999, Rj_Cl=0.19, Rj_HCO₃=0.19, and Rj_Co₃=0.8.

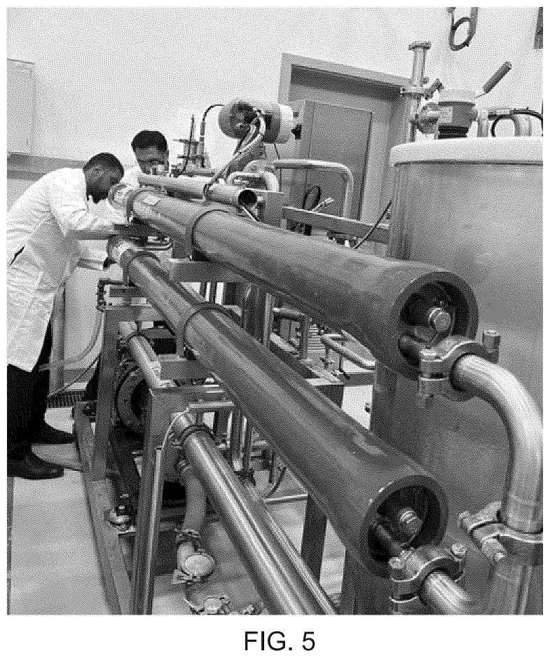

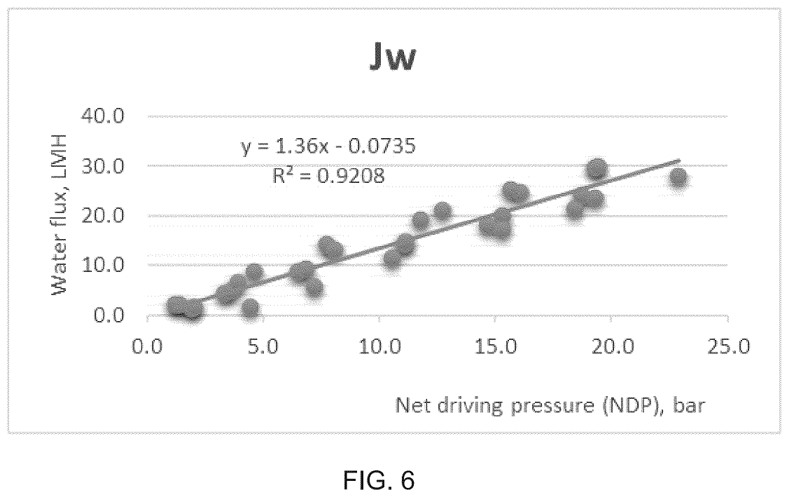

FIG. 5 shows an NF pilot plant desalination lab (QEERI) and FIG. 6 shows NF membrane characterization determining A and B coeffect.

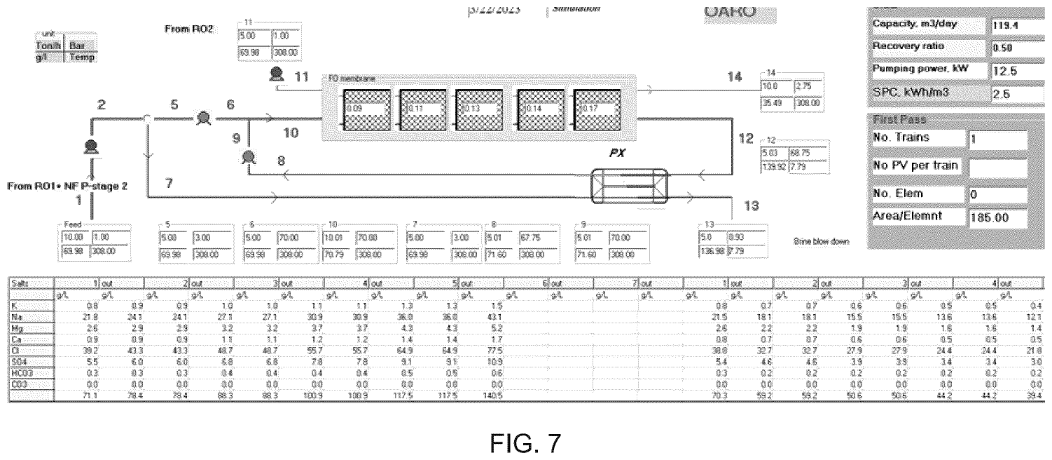

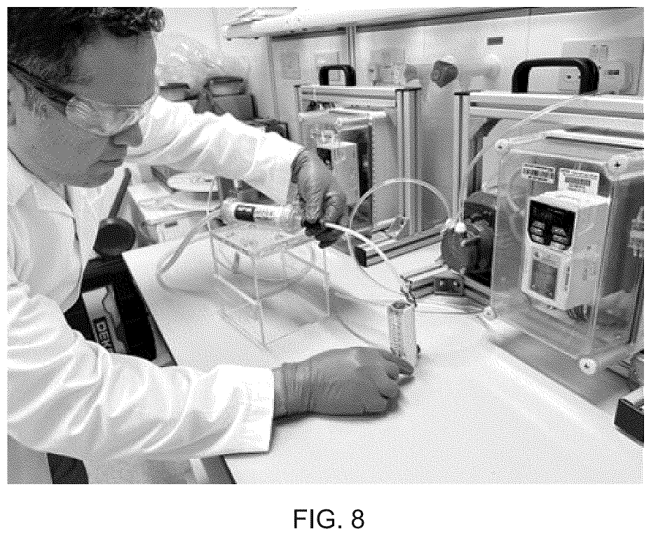

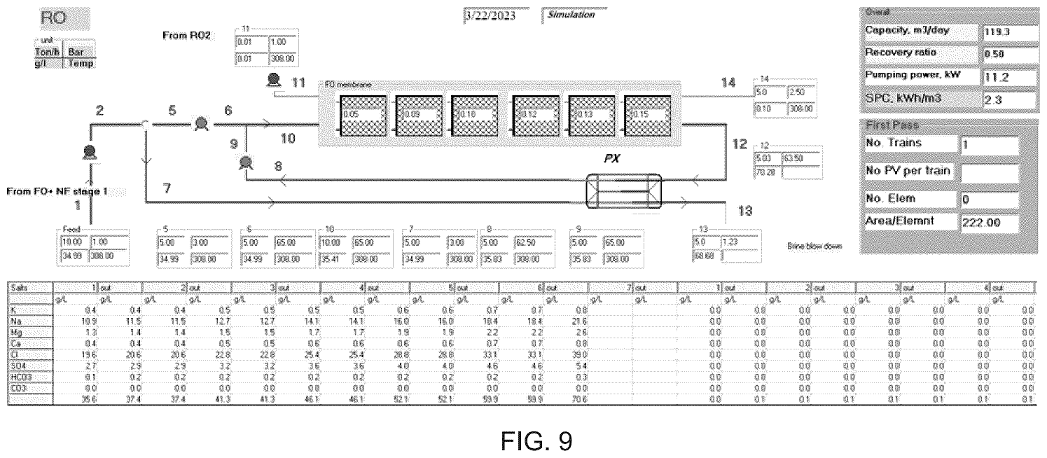

Simulation Results: The Disclosed Invention includes a mathematical model of the FO system. A computer program (VSP) solves the mathematical model equations. By solving the mathematical model, the process performance is calculated. The process production and recovery are calculated. The composition of seawater is fed (input) to the VSP software, and the number of membrane elements. The species of the inorganic salt concentration are calculated for each stream as seen in FIG. 7. FIG. 7 shows results for a process simulation of the Osmotic Assisted Reverse Osmosis Membrane (FO) System. FIG. 8 shows a hollow fibre FO membrane set up. FIG. 9 shows results for a mathematical model of a Reverse Osmosis (RO).

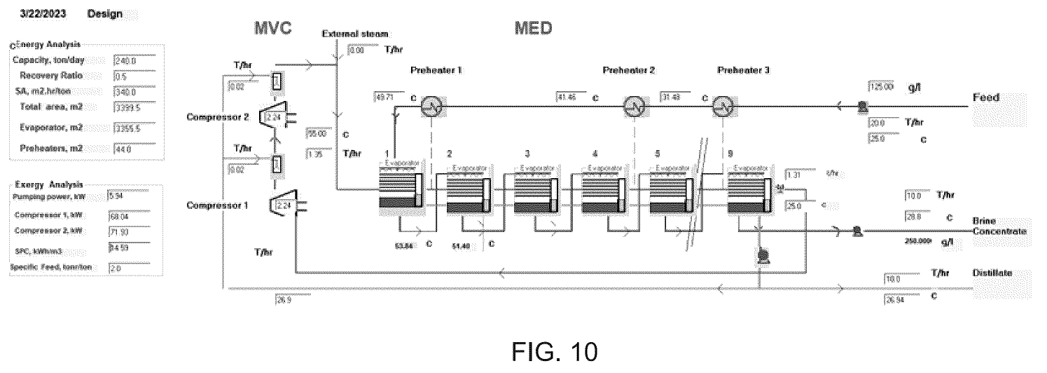

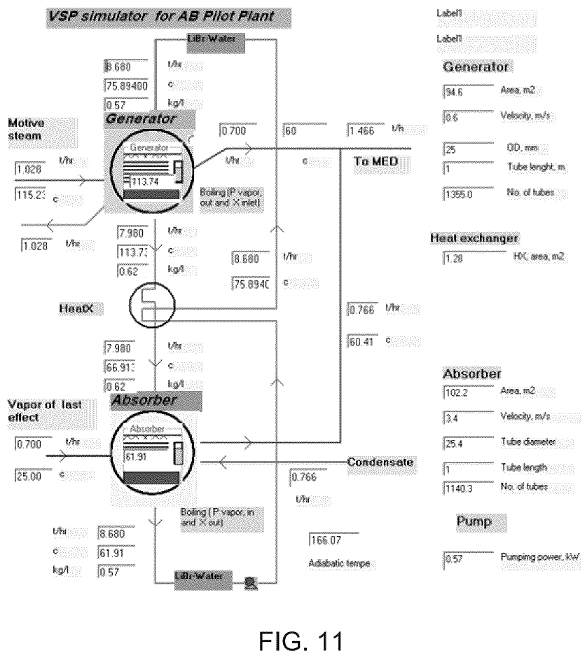

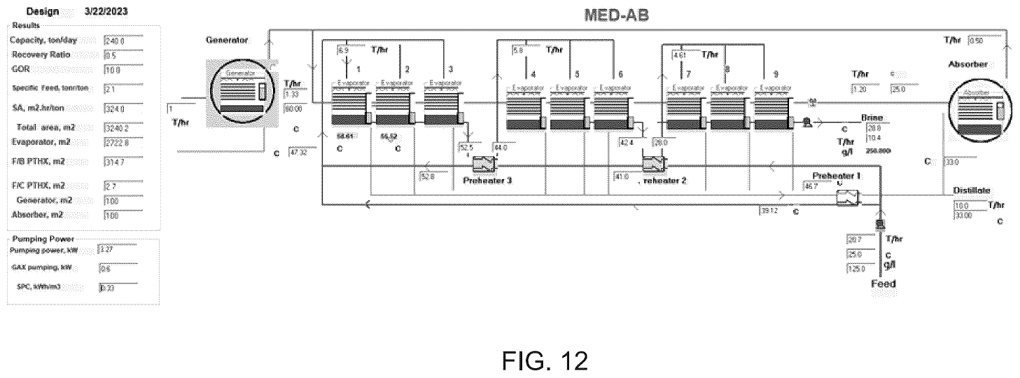

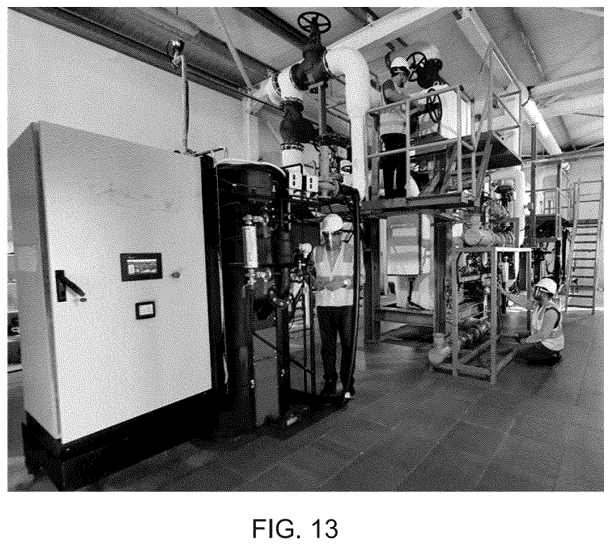

FIG. 10 shows results for a mathematical model of a Forward Feed Multi Effect Distillation (MED) process. FIG. 11 shows results for a mathematical model of a brine concentrator and water recovery process. FIG. 12 shows results for a mathematical model of a Forward Feed MED-AB process. Finally, FIG. 13 shows an advanced MED-AB pilot plant at Dukhan, Qatar.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The invention is claimed as follows:

1. A method for brine concentration and water recovery comprising:
feeding a brine stream into a first stage nano filtration process, wherein the nano filtration process separates divalent ions from the brine stream;
feeding a rejected stream from the first stage nano filtration process to a second stage nano filtration process;
feeding a permeate stream from the first stage nano filtration process to a first reverse osmosis system, wherein the first reverse osmosis system generates a potable freshwater stream;
feeding a brine concentrate stream of the second state nano filtration to the feed side of a third nano filtration process, and directing the brine concentrate stream to a brine mining process;
recovering a first pressure energy from the brine concentrate stream via a first energy recovery system, wherein the first pressure energy is reverted to the brine stream to reduce energy consumption of the first, second, and third state nano filtration processes;
mixing the brine rejects of the first reverse osmosis system and a permeate stream from the second stage nano filtration process into a first mixed stream;
subjecting the first mixed stream to a pressure greater than osmotic pressure;
directing the mixed stream to a feed side of a forward osmosis system including an osmotic membrane, wherein the osmotic membrane is fluidly coupled to a second reverse osmosis system on a dilute side opposite the feed side, such that there is a pressure differential between the first mixed stream on the feed side of the osmotic membrane and the second reverse osmosis system on the dilute side;
wherein the dilute side has low pressure and the feed side has high pressure;
diluting the first mixed stream and directing the diluted mixed stream to the second reverse osmosis system;
recovering a second pressure energy from the diluted mixed stream via a second energy recovery system, wherein the second pressure energy is reverted to the second osmosis system;
mixing a concentrated mixed stream from the dilute side with a permeate stream from the third stage nano filtration into a second mixed stream; and
directing the second mixed stream into a thermal brine concentrator.

2. The method of claim 1, wherein the brine stream has a salinity of about 50-90 g/L.

3. The method of claim 1, wherein the brine mining process comprises subjecting the brine concentrate stream to further precipitation of the CaCo₃ and Mg SO₄ salts using a chemical approach.

4. The method of claim 3, wherein the chemical approach separates the divalent ions before reaching supersaturation.

5. The method of claim 1, wherein the thermal bring concentration comprises a vapor compressor and an evaporator.

6. The method claim 5, wherein the vapor compressor circulates vapor to increase pressure and to heat the evaporator.

7. The method of claim 1, wherein an overall water recovery from the initial brine stream is about 75%.

8. The method of claim 1, wherein a resulting feed brine leaves the evaporator with a salinity of about 250-300 g/L before being directed to a crystallizer.

9. A method for brine concentration and water recovery comprising:
feeding a brine stream into a first stage nano filtration process, wherein the nano filtration process separates divalent ions from the brine stream;
feeding a rejected stream from the first stage nano filtration process to a second stage nano filtration process;
feeding a permeate stream from the first stage nano filtration process to a reverse osmosis system, wherein the reverse osmosis system generates a potable freshwater stream;
feeding a brine concentrate stream of the second state nano filtration to the feed side of a third nano filtration process, and directing the brine concentrate stream to a brine mining process;
recovering pressure energy from the brine concentrate stream via a first energy recovery system, wherein the pressure energy is reverted to the brine stream to reduce energy consumption of the first, second, and third state nano filtration processes;
mixing the brine rejects of the first reverse osmosis system and a permeate stream from the second stage nano filtration process into a first mixed stream;
subjecting the first mixed stream to a pressure greater than osmotic pressure;
directing the mixed stream to a feed side of a forward osmosis system including an osmotic membrane, wherein the osmotic membrane is fluidly coupled to a Multi Effect Distillation with Absorption compressor (MED-AB) thermal brine concentrator system on a dilute side opposite the feed side, such that there is a pressure differential between the first mixed stream on the feed side of the osmotic membrane and the Multi Effect Distillation with Absorption compressor (MED-AB) thermal brine concentrator system on the dilute side;
wherein the dilute side has low pressure and the feed side has high pressure;
diluting the first mixed stream and directing the diluted mixed stream to the Multi Effect Distillation with Absorption compressor (MED-AB) thermal brine concentrator system;
recovering pressure energy from the diluted mixed stream via a second energy recovery system, wherein the pressure energy is reverted to the Multi Effect Distillation with Absorption compressor (MED-AB) thermal brine concentrator system;
mixing a concentrated mixed stream from the dilute side with a permeate stream from the third stage nano filtration into a second mixed stream; and
directing the second mixed stream into a thermal brine concentrator.

10. The method of claim 9, wherein the brine stream has a salinity of 50-90 g/L.

11. The method of claim 9, wherein the brine mining process comprises subjecting the brine concentrate stream to further precipitation of the CaCo₃ and Mg SO₄ salts using a chemical approach.

12. The method of claim 11, wherein the chemical approach separates the divalent ions before reaching supersaturation.

13. The method of claim 9, wherein the thermal bring concentration comprises a vapor compressor and an evaporator.

14. The method claim 13, wherein the vapor compressor circulates vapor to increase pressure and to heat the evaporator.

15. The method of claim 9, wherein an overall water recovery from the initial brine stream is about 75%.

16. The method of claim 9, wherein a resulting feed brine leaves the evaporator with a salinity of about 250-300 g/L before being directed to a crystallizer.
